(19) United States
(12) Patent Application Publication
(10) Pub. No.: US 2011/0006593 A1
(43) Pub. Date: Jan. 13, 2011

(54) BRAKE CONTROL APPARATUS

(75) Inventors: Akira Sakai, Aichi-ken (JP); Shiro Monzaki, Shizuoka-ken (JP); Mitsuo Fukuda, Kanagawa-ken (JP); Eiji Nakamura, Aichi-ken (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Toyota Jidosha Kabushiki Kaisha, Aichi-ken (JP)

(21) Appl. No.: 12/919,389

(22) PCT Filed: Feb. 26, 2009
(86) PCT No.: PCT/IB2009/000371

§ 371 Date: Aug. 25, 2010

(30) Foreign Application Priority Data
Feb. 29, 2008 (JP) 2008 050398

(51) Int. Cl. B60T 13/13; B60T 13/128; B60T 13/14; B60T 13/16; B60T 8/34; B60T 8/176

(52) U.S. Cl. 303/6.01; 303/13; 303/113.1

(57) ABSTRACT

In a brake control apparatus (20) that controls braking forces which are applied to wheels based on the pressure of a brake fluid, when a hydraulic pressure actuator (40) controls the hydraulic pressure that is transferred to wheel cylinders (23) using the hydraulic pressure of the brake fluid in a power hydraulic pressure source (30), a brake ECU (70) closes a simulator cut valve (68) if the pressure of the brake fluid in the power hydraulic pressure source (30) falls below a predetermined value (Pssc) or if it is determined that the number of times the brake operation member (24) is operated within a predetermined value. In addition, the ECU (70) may change the timing for closing the simulator cut valve (68) based on the road surface condition estimated at the time of antilock control start. Thus, a driver is less likely to feel unusual brake feel when a braking control mode is changed.

### BACKGROUND OF THE INVENTION

1. Field of the Invention

The invention relates generally to a brake control apparatus and brake control method that controls barking forces that are applied to wheels of a vehicle, and more specifically to a technology for enhancing the brake feel with the use of the brake control apparatus.

2. Description of the Related Art

There is a hydraulic pressure control apparatus that generates a hydraulic pressure in a hydraulic circuit in accordance with an operation amount of a brake pedal and supplies the hydraulic pressure in the hydraulic circuit to wheel cylinders, thereby applying braking forces of wheels of a vehicle. Also, there is a hydraulic pressure control apparatus that is provided with an actuator which includes a pair of electromagnetically-controlled valves used to increase or decrease the pressures in wheel cylinders provided for respective wheels, and an electronic control unit that controls the actuator. With the hydraulic pressure control apparatus, the amount by which the brake pedal is operated by a driver is detected by, for example, a sensor and translated into an electric signal, and the electric signal is transmitted to the electronic control unit. Then, the electromagnetically-controlled valve for increasing the pressure or the electromagnetically-controlled valve for decreasing the pressure is controlled by the electronic control unit, whereby the pressures in the wheel cylinders for the four wheels are controlled appropriately and independently of each other. Therefore, high travelling safety and safety are achieved.

As such a hydraulic pressure control apparatus, a hydraulic pressure brake control apparatus is described in Japanese Patent Application Publication No. 2006-123889 (JP-A-2006-123889). When a predetermined type of abnormality is detected, the hydraulic pressure brake control apparatus described in JP-A-2006-123889 is switched from a regular control mode, which has been selected, to a mode in which a partition valve that partitions a system into a front wheel-side system and a rear wheel-side system is closed to provide communication between a hydraulic pressure booster and wheel cylinders and a brake operation is performed directly with the use of the hydraulic pressure generated in response to an operation of a brake pedal performed by a driver.

The hydraulic pressure brake control apparatus described in JP-A-2006-123889 includes the hydraulic pressure booster that amplifies a brake operating force. Communication between an accumulator and a booster chamber of the hydraulic pressure booster is permitted when a piston that operates in accordance with the brake pedal moves, and the brake operating force is assisted by the hydraulic pressure accumulated in the accumulator.

In such a hydraulic pressure brake control apparatus, the brake fluid is supplied from the accumulator to the booster chamber each time a brake operation is performed. Therefore, the hydraulic pressure in the accumulator gradually decreases. Accordingly, the hydraulic pressure brake control apparatus drives a pump when the hydraulic pressure detected by an accumulator pressure sensor is equal to or lower than a predetermined hydraulic pressure, and increases the hydraulic pressure until the hydraulic pressure in the accumulator reaches the predetermined hydraulic pressure with the use of the pressurized brake fluid.

However, if a certain type of brake operation, for example, a pumping operation is performed, the amount of brake fluid that is supplied from the accumulator to the booster chamber increases in a short time. Therefore, even if the pump is driven, the amount of brake fluid that is supplied to the accumulator may fall below the amount of brake fluid that is discharged from the accumulator. The same inconvenience may occur if a pump malfunctions and cannot exhibit sufficient performance.

In such a case, the pressure in the accumulator further decreases. Therefore, the hydraulic pressure brake control apparatus described above is switched from the regular braking control mode, in which the braking forces that are supplied from the power hydraulic pressure source to the four wheels are controlled independently of each other, to the mode, in which a brake operation is performed directly with the use of the hydraulic pressure that is generated in the master cylinder in response of an operation of the brake pedal performed by the driver. Such a mode switching may be a factor of a change in the characteristics of a braking force, which causes a driver to feel unusual brake feel. Accordingly, there is a demand for further enhancement in the brake feel.

### SUMMARY OF THE INVENTION

The invention provides a technology for suppressing a decrease in the hydraulic pressure in a power hydraulic pressure source due to repeated brake operation, a malfunction in a pump, etc., thereby enhancing the brake feel.

A first aspect of the invention relates to a brake control apparatus that controls a braking force which is applied to a wheel based on a hydraulic pressure of a hydraulic fluid. The brake control apparatus includes a manual hydraulic pressure source that pressurizes the hydraulic fluid based on the amount by which a brake operation member is operated by a driver, a power hydraulic pressure source that is able to deliver the hydraulic fluid pressurized by supplied drive power independently of any operations of the brake operation member, a hydraulic circuit which connects the manual hydraulic pressure source and the power hydraulic pressure source to a wheel cylinder that applies a braking force to the wheel, and in which a passage is formed so that the hydraulic pressure of the hydraulic fluid in the manual hydraulic pressure source and the hydraulic pressure of the hydraulic fluid in the power hydraulic pressure source are transferred to the wheel cylinder, a pressure control mechanism that switches a passage through which the hydraulic fluid that is supplied from at least one of the manual hydraulic pressure source and the power hydraulic pressure source flows, thereby controlling the hydraulic pressure of the hydraulic fluid that is transferred to the wheel cylinder, a stroke simulator that is connected to the hydraulic circuit and that generates a reaction force corresponding to an operation of the brake operation member using the hydraulic fluid delivered from the manual hydraulic pressure source, a simulator cut valve that controls a flow of the hydraulic fluid into the stroke simulator, and a control unit that controls an open/closed state of the simulator cut valve and the pressure control mechanism. The manual hydraulic pressure source includes a first hydraulic pressure generation unit that is connected to the power hydraulic pressure source and that generates a hydraulic pressure which assists a force, with which the brake operation member is operated, using the hydraulic fluid that is pressurized in the power hydraulic pressure source, and a second hydraulic pressure generation unit that is connected to a passage which leads to the stroke simulator and that generates a hydraulic pressure which corresponds to the sum of the force, with which the brake operation member is operated, and the hydraulic pressure generated in the first hydraulic pressure generation unit. When the pressure control mechanism controls the hydraulic pressure that is transferred to the wheel cylinder using the hydraulic pressure of the hydraulic fluid in the power hydraulic pressure source, the control unit closes the simulator cut valve when the hydraulic pressure of the hydraulic fluid in the power hydraulic pressure source falls below a predetermined value.

A second aspect of the invention relates to a brake control apparatus that controls braking forces which are applied to wheels based on a hydraulic pressure of a hydraulic fluid. The brake control apparatus includes a manual hydraulic pressure source that pressurizes the hydraulic fluid based on the amount by which a brake operation member is operated by a driver, a power hydraulic pressure source that is able to deliver the hydraulic fluid pressurized by supplied drive power independently of any operations of the brake operation member, a pressure sensor that detects the hydraulic pressure of the hydraulic fluid pressurized in the power hydraulic pressure source, a first hydraulic circuit which connects the manual hydraulic pressure source to a first wheel cylinder that applies a braking force to a first wheel, and in which a passage is formed so that the hydraulic pressure of the hydraulic fluid in the manual hydraulic pressure source is transferred to the first wheel cylinder, a second hydraulic circuit which connects the manual hydraulic pressure source to a second wheel cylinder that applies a braking force to a second wheel that differs from the first wheel, and in which a passage is formed so that the hydraulic pressure of the hydraulic fluid in the manual hydraulic pressure source is transferred to the second wheel cylinder, a third hydraulic circuit which connects the power hydraulic pressure source to the first wheel cylinder and the second wheel cylinder, and in which a passage is formed so that the hydraulic pressure of the hydraulic fluid in the power hydraulic pressure source is transferred to the first wheel cylinder and the second wheel cylinder, a pressure control mechanism that switches a passage through which the hydraulic fluid that is supplied from at least one of the manual hydraulic pressure source and the power hydraulic pressure source flows, thereby controlling the hydraulic pressure of the hydraulic fluid that is transferred to at least one of the first wheel cylinder and the second wheel cylinder, a stroke simulator that is connected to the first hydraulic circuit and that generates a reaction force corresponding to an operation of the brake operation member using the hydraulic fluid delivered from the manual hydraulic pressure source, a simulator cut valve that controls a flow of the hydraulic fluid into the stroke simulator, and a control unit that controls an open/closed state of the simulator cut valve and the pressure control mechanism. The manual hydraulic pressure source includes a first hydraulic pressure generation unit that is provided between and connected to the power hydraulic pressure source and the second hydraulic circuit and that generates a hydraulic pressure which assists a force, with which the brake operation member is operated, using the hydraulic fluid that is pressurized in the power hydraulic pressure source, and a second hydraulic pressure generation unit that is connected to the first hydraulic circuit and that generates a hydraulic pressure which corresponds to the sum of the force, with which the brake operation member is operated, and the hydraulic pressure generated in the first hydraulic pressure generation unit. When the pressure control mechanism controls the hydraulic pressure that is transferred to the first wheel cylinder and the second wheel cylinder using the hydraulic pressure of the hydraulic fluid in the power hydraulic pressure source, the control unit closes the simulator cut valve when the hydraulic pressure of the hydraulic fluid in the power hydraulic pressure source falls below a predetermined value.

In the brake control apparatus described above, when the brake operation member is operated and the simulator cut valve is open, the hydraulic fluid flows into the stroke simulator, whereby a reaction force corresponding to an operation of the brake operation member is generated. At this time, because the hydraulic fluid that flows into the stroke simulator is delivered from the second hydraulic pressure generation unit of the manual hydraulic pressure source, the volume of the second hydraulic pressure generation unit decreases. In accordance with this, the brake operation member is moved by the operation force, with which the brake operation member is operated, and the volume of the first hydraulic pressure generation unit that generates the hydraulic pressure, which assist the operation force, is increased. Therefore, the hydraulic pressure generated in the first hydraulic pressure generation unit decreases, and the hydraulic fluid is further supplied from the power hydraulic pressure source in order to compensate for the decrease.

In the brake control apparatus described above, the pressurized hydraulic fluid in the power hydraulic pressure source is used to transfer the hydraulic pressure to the wheel cylinders via the hydraulic circuit. Therefore, if the brake operation is performed frequently, the hydraulic fluid is not sufficiently pressurized by the supplied drive power alone. Accordingly, it is estimated that the hydraulic pressure of the hydraulic fluid in the power hydraulic pressure source will fall below the minimum hydraulic pressure value that is required to perform the brake operation using mainly the power hydraulic pressure source. In such a case, for example, the pressure control mechanism controls the hydraulic pressure that is transferred to the wheel cylinders using the hydraulic fluid that is supplied from the manual hydraulic pressure source via the hydraulic circuit. If the supply source of the hydraulic fluid that transfers the hydraulic pressure during the brake operation is switched from the power hydraulic pressure source to the manual hydraulic pressure source, the driver feels unusual brake feel. In this case, the minimum hydraulic pressure value that is required to perform the brake operation using mainly the power hydraulic pressure source may be regarded as a threshold value that is used when the main supply source of the hydraulic fluid that transfers the hydraulic pressure during the brake operation is switched from the power hydraulic pressure source to the manual hydraulic pressure source.

Therefore, according to the aspects of the invention described above, when the hydraulic pressure of the hydraulic fluid in the power hydraulic pressure source falls below the predetermined value, the simulator cut valve is closed. Thus, the hydraulic fluid is prevented from flowing into the stroke simulator, and the amount of hydraulic fluid that is delivered from the second hydraulic pressure generation unit of the manual hydraulic pressure source decreases. Therefore, it is possible to suppress a change in the volume of the second hydraulic pressure generation unit. Accordingly, a change in the volume of the first hydraulic pressure generation unit is suppressed, and the amount of hydraulic fluid that is delivered from the power hydraulic pressure source to the first hydraulic pressure generation unit is decreased. Therefore, it is possible to suppress a decrease in the pressure of the hydraulic fluid that is pressurized in the power hydraulic pressure source. As a result, it is possible to suppress switching of the supply source of the hydraulic fluid that transfers the hydraulic pressure during the brake operation from the power hydraulic pressure source to the manual hydraulic pressure source, thereby enhancing the brake feel. In this case, the predetermined value may be set to a value that is larger than the minimum hydraulic pressure value that is required to perform the brake operation using mainly the power hydraulic pressure source. In addition, the predetermined value may be set to a value that is smaller than the hydraulic pressure value at which pressurization using the drive power is started because the hydraulic pressure of the hydraulic fluid in the power hydraulic pressure source is decreased. The predetermined value may be empirically set in consideration of a decrease in the stroke amount of the brake operation member caused by closing the simulator cut valve and a decrease in the hydraulic pressure of the hydraulic fluid in the power hydraulic pressure source due to an increase in the hydraulic fluid that is supplied to the stroke simulator, which is caused by opening the simulator cut valve.

The brake control apparatus may further include an operation times detection unit that detects the number of times the brake operation member is operated. The control unit may close the simulator cut valve, when it is determined that the number of times the brake operation member is operated within a predetermined period is equal to or larger than a predetermined value. The amount of hydraulic fluid that is supplied from the power hydraulic pressure source increases with an increase in the number of times the brake operation member is operated. Therefore, if the number of times the brake operation member is operated within the predetermined period is too large, the hydraulic fluid is not sufficiently pressurized by the supplied drive power alone. Accordingly, the possibility that the hydraulic pressure of the hydraulic fluid in the power hydraulic pressure source decreases is increased. Therefore, if it is determined that the number of times that the brake operation member is operated within the predetermined period is equal to or larger than the predetermined value, the simulator cut valve is closed. Thus, it is possible to more accurately suppress a decrease in the hydraulic pressure of the hydraulic fluid in the power hydraulic pressure source. In this case, the predetermined number of times may be empirically set in consideration of the degree to which the hydraulic fluid is allowed to pressurized in the power hydraulic pressure source using the supplied drive power and the amount of hydraulic fluid that is delivered from the power hydraulic pressure source each time the brake operation member is operated.

A third aspect of the invention relates to a brake control apparatus that controls braking forces which are applied to wheels based on a hydraulic pressure of a hydraulic fluid. The brake control apparatus includes a manual hydraulic pressure source that pressurizes the hydraulic fluid based on the amount by which a brake operation member is operated by a driver, a power hydraulic pressure source that is able to deliver the hydraulic fluid pressurized by supplied drive power independently of any operations of the brake operation member, an operation times detection unit that detects the number of times the brake operation member is operated, a first hydraulic circuit which connects the manual hydraulic pressure source to a first wheel cylinder that applies a braking force to a first wheel, and in which a passage is formed so that the hydraulic pressure of the hydraulic fluid in the manual hydraulic pressure source is transferred to the first wheel cylinder, a second hydraulic circuit which connects the manual hydraulic pressure source to a second wheel cylinder that applies a braking force to a second wheel that differs from the first wheel, and in which a passage is formed so that the hydraulic pressure of the hydraulic fluid in the manual hydraulic pressure source is transferred to the second wheel cylinder, a third hydraulic circuit which connects the power hydraulic pressure source to the first wheel cylinder and the second wheel cylinder, and in which a passage is formed so that the hydraulic pressure of the hydraulic fluid in the power hydraulic pressure source is transferred to the first wheel cylinder and the second wheel cylinder, a pressure control mechanism that switches a passage through which the hydraulic fluid that is supplied from at least one of the manual hydraulic pressure source and the power hydraulic pressure source flows, thereby controlling the hydraulic pressure of the hydraulic fluid that is transferred to at least one of the first wheel cylinder and the second wheel cylinder, a stroke simulator that is connected to the first hydraulic circuit and that generates a reaction force corresponding to an operation of the brake operation member using the hydraulic fluid, delivered from the manual hydraulic pressure source, a simulator cut valve that controls a flow of the hydraulic fluid into the stroke simulator, and a control unit that controls an open/closed state of the simulator cut valve and the pressure control mechanism. The manual hydraulic pressure source includes a first hydraulic pressure generation unit that is provided between and connected to the power hydraulic pressure source and the second hydraulic circuit and that generates a hydraulic pressure which assists a force, with which the brake operation member is operated, using the hydraulic fluid that is pressurized in the power hydraulic pressure source, and a second hydraulic pressure generation unit that is connected to the first hydraulic circuit and that generates a hydraulic pressure which corresponds to the sum of the force, with which the brake operation member is operated, and the hydraulic pressure generated in the first hydraulic pressure generation unit. When the pressure control mechanism controls the hydraulic pressure that is transferred to the first wheel cylinder and the second wheel cylinder using the hydraulic pressure of the hydraulic fluid in the power hydraulic pressure source, the control unit closes the simulator cut valve when it is determined that the number of times the brake operation member is operated within the predetermined period is equal to or larger than the predetermined value.

According to the third aspect of the invention, when it is determined that the number of times the brake operation member is operated within the predetermined period is equal to or larger than the predetermined value, the simulator cut valve is closed. Thus, the hydraulic fluid is prevented from flowing into the stroke simulator, and the amount of hydraulic fluid that is delivered from the second hydraulic pressure generation unit of the manual hydraulic pressure source decreases. Accordingly, a change in the volume of the second hydraulic pressure generation unit is suppressed. Therefore, a change in the volume of the first hydraulic pressure generation unit is also suppressed, and the amount of hydraulic fluid that is delivered from the power hydraulic pressure source to the first hydraulic pressure generation unit is decreased. Thus, a decrease in the pressure of the hydraulic fluid that is pressurized in the power hydraulic pressure source is suppressed. As a result, it is possible to suppress switching of the supply source of the hydraulic fluid that transfers the hydraulic pressure during the brake operation from the power hydraulic pressure source to the manual hydraulic pressure source, thereby enhancing the brake feel. In addition, it is possible to close the simulator cut valve when necessary, even if a unit that detects the hydraulic pressure of the hydraulic fluid in the power hydraulic pressure source is not provided. As a result, the number of components of the apparatus and cost are reduced.

The brake control apparatus may further include a stroke sensor that detects a stroke amount of the brake operation member. The control unit may close the simulator cut valve when the stroke amount of the brake operation member reaches a predetermined amount. Thus, a predetermined stroke amount is achieved within a period from when an operation of the brake operation member is started until when the simulator cut valve is closed. As a result, it is possible to reduce unusual brake feel that is felt by the driver when the simulator cut valve is closed.

The control unit may include a road surface condition estimation unit that estimates the road surface condition that is correlated with slip of the wheel after antilock control is started. The control unit changes timing for closing the simulator cut valve based on the road surface condition. When the antilock control is started, the driver feels brake feel that differs from the brake feel which is felt by the driver during the regular braking control. Accordingly, the necessity to generate a reaction force with the use of the stroke simulator is reduced. Meanwhile, the magnitude of braking force at which the antilock control is started and the timing for starting the antilock control vary depending on the road surface condition. Therefore, during the antilock control, the timing for closing the simulator cut valve is changed based on the road surface condition. In this way, it is possible to suppress unusual brake feel that is felt by the driver when the simulator cut valve is closed, while suppressing the amount of brake fluid that is consumed in the stroke simulator.

The brake control apparatus may further include a stroke sensor that detects a stroke amount of the brake operation member, and a hydraulic pressure sensor that detects the hydraulic pressure which is transferred to at least one of the first wheel cylinder and the second wheel cylinder. The road surface condition estimation unit may estimate a coefficient of friction between the wheel and the road surface based on a pressure-decrease start pressure at which the hydraulic pressure that is detected by the hydraulic pressure sensor starts decreasing after the antilock control is started, and uses the estimated coefficient of friction as the road surface condition. The control unit may close the simulator cut valve after the stroke amount of the operation member reaches a predetermined amount that is set based on the coefficient of friction.

The timing for locking the wheel varies depending on the coefficient of friction between the wheel and the road surface and the hydraulic pressure used to generate a braking force. In the antilock control, the hydraulic pressure in the wheel cylinder is temporarily decreased in order to cancel locking of the wheel. Therefore, according to the aspect of the invention described above, the coefficient of friction between the wheel and the road surface is estimated based on the pressure-decrease start pressure. Therefore, when the coefficient of friction is high and the stroke amount of the brake operation member that is achieved until the antilock control is started is large, the stroke amount that is achieved until the simulator cut valve is closed is increased. On the other hand, when the coefficient of friction is low and the stroke amount of the brake operation member that is achieved until the antilock control is started is small, the stroke amount that is achieved until the simulator cut valve is closed is decreased.

The invention may be expressed in the other forms such as programs, systems, and vehicles.

With the brake control apparatus according to the aspects of the invention described above, it is possible to enhance the brake feel.

### BRIEF DESCRIPTION OF THE DRAWINGS

The foregoing and further features and advantages of the invention will become apparent from the following description of example embodiments with reference to the accompanying drawings, wherein the same or corresponding portions will be denoted by the same reference numerals and wherein:

FIG. 1 is a system diagram showing a brake control apparatus according to a first embodiment of the invention;

FIG. 2 is a flowchart for describing a control routine executed in a cooperative braking control mode;

FIG. 3 is a graph showing the relationship between the amount of brake fluid in an accumulator and the pressure accumulated in the accumulator;

FIG. 4 is a flowchart for describing a routine for suppressing the amount of brake fluid that flows into a stroke simulator according to the first embodiment of the invention;

FIG. 5 is a flowchart for describing a routine for suppressing the amount of brake fluid that flows into the stroke simulator according to a second embodiment of the invention;

FIG. 6 is a flowchart for describing a routine for determining the timing for closing a simulator cut valve according to a third embodiment of the invention;

FIG. 7 is a flowchart showing the details of a simulator cut valve closing timing determination routine;

FIG. 8 is a graph showing a temporal change in the wheel cylinder pressure during ABS control;

FIG. 9 is a graph showing the relationship between a pressure-decrease start pressure Pd and an estimated friction coefficient μ; and

FIG. 10 is a graph showing the relationship between the estimated friction coefficient μ and a stroke amount that is permitted to be achieved in a period until the simulator cut valve is closed.

### DETAILED DESCRIPTION OF THE EMBODIMENTS

Hereafter, example embodiments of the invention will be described in detail with reference to the accompanying drawings. In the description of the drawings, the same elements will be denoted by the same reference numerals. The description concerning the elements having the same reference numerals will be provided only once below.

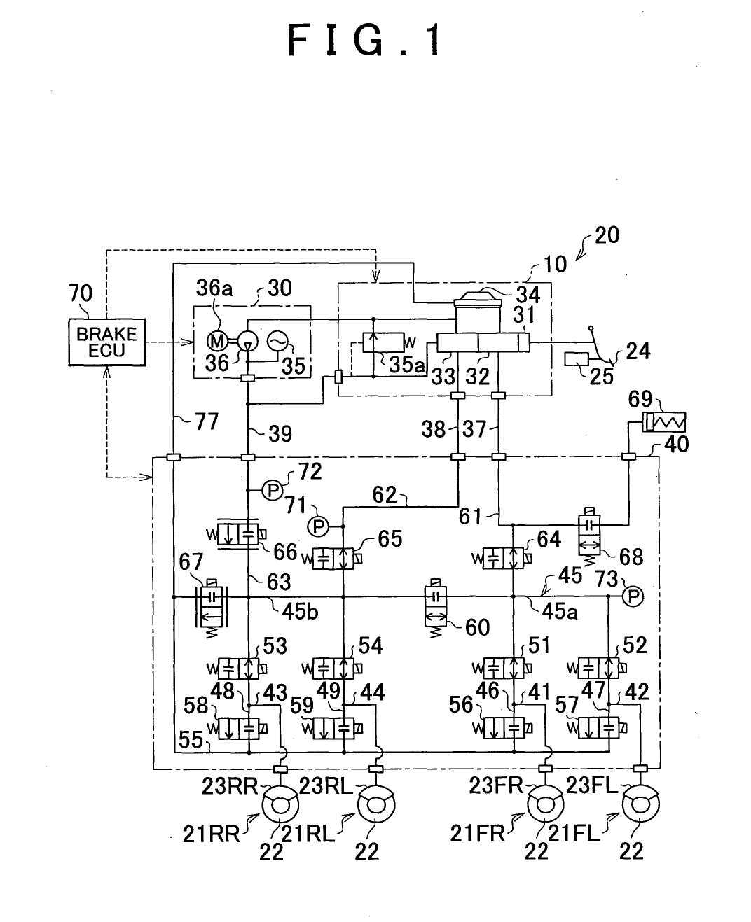

Hereafter, a first embodiment of the invention will be described. FIG. 1 is a system diagram showing a brake control apparatus 20 according to the first embodiment of the invention. The brake control apparatus 20 shown in FIG. 1 forms an electronically-controlled brake system for a vehicle, and controls braking forces that are applied to four wheels of a vehicle. The brake control apparatus 20 according to the first embodiment of the invention is mounted in, for example, a hybrid vehicle provided with an electric motor and an internal combustion engine that serve drive power sources. In such a hybrid vehicle, each of regenerative braking control and hydraulic braking control may be executed to apply brakes to the vehicle. In the regenerative braking control, kinetic energy of the vehicle is converted into electric energy to apply brakes to the vehicle. The brake control apparatus 20 executes the hydraulic braking control. In the vehicle according to the first embodiment of the invention, cooperating braking control may be executed. In the cooperative braking control, the regenerative braking control and the hydraulic braking control are executed in combination to produce a desired braking force.

As shown in FIG. 1, the brake control apparatus 20 includes disc brake units 21FR, 21FL, 21RR and 21RL that serve as braking force application mechanisms fitted to respective four wheels (not shown), a master cylinder unit 10, a power hydraulic pressure source 30, and a hydraulic actuator 40.

The disc brake units 21FR, 21FL, 21RR and 21RL apply braking forces to a right front wheel, a left front wheel, a right rear wheel and a left rear wheel of the vehicle, respectively. The master cylinder unit 10, which serves as a manual hydraulic pressure source, delivers brake fluid pressurized in accordance with the amount by which a brake pedal 24, which serves as a brake operation member, is operated by a driver to the disc brake units 21FR, 21FL, 21RR and 21RL. The power hydraulic pressure source 30 delivers the brake fluid, used as the hydraulic fluid and pressurized by supplied drive power, to the disc brake units 21FR, 21FL, 21RR and 21RL independently of any operations of the brake pedal 24 performed by the driver. The hydraulic actuator 40 adjusts, on an as-required basis, the hydraulic pressure of the brake fluid supplied from the power hydraulic pressure source 30 or the master cylinder unit 10, and then delivers the brake fluid to the disc brake units 21FR, 21FL, 21RR and 21RL. Thus, the braking forces that are applied to the respective wheels through the hydraulic pressure brake operation are adjusted. In the first embodiment of the invention, elements that constitute a wheel cylinder pressure control system include the power hydraulic pressure source 30 and the hydraulic actuator 40. As described above, the brake control apparatus 20 controls the braking forces that are applied to the wheels based on the pressure of the brake fluid.

The disc brake units 21FR, 21FL, 21RR and 21RL, the master cylinder unit 10, the power hydraulic pressure source 30, and the hydraulic actuator 40 will be described below in more detail. The disc brake units 21FR, 21FL, 21RR and 21RL include brake discs 22, and wheel cylinders 23FR, 23FL, 23RR and 23RL incorporated in brake calipers, respectively. The wheel cylinders 23FR to 23RL are connected to the hydraulic actuator 40 via respective fluid passages. Hereinafter, the wheel cylinders 23FR to 23RL will be collectively referred to as “wheel cylinders 23”, where appropriate. As described above, the hydraulic actuator 40 serves as a pressure control mechanism that controls the pressure of the brake fluid that is delivered to the wheel cylinders 23 by switching passages of the brake fluid that is supplied from at least one of the master cylinder unit 10 and the power hydraulic pressure source 30. The hydraulic actuator 40 includes a hydraulic pressure sensor and multiple control valves that are used to switch the passages of the brake fluid and to shut off the passages. The details of the hydraulic actuator 40 will be described later in detail. The hydraulic actuator 40 according to the first embodiment of the invention includes part of a hydraulic circuit formed of multiple fluid passages that provide communication between the power hydraulic pressure source 30 or the master cylinder unit 10 and the wheel cylinders 23 and that transmit the pressure of the brake fluid in the power hydraulic pressure source 30 or the master cylinder apparatus 20 to the wheel cylinders 23.

In the disc brake units 21FR, 21FL, 21RR and 21RL, when the brake fluid is supplied from the hydraulic actuator 40 to the wheel cylinders 23, brake pads that serve as friction members are pushed against the brake discs 22 that rotate together with the wheels. Thus, braking force is applied to each wheel. In the first embodiment of the invention, the disc brake units 21FR to 21RL are used. Alternatively, other braking force applying mechanisms that include wheel cylinders, for example, drum brake units may be used.

In the first embodiment of the invention, the master cylinder unit 10 is provided with a hydraulic pressure booster 31. The master cylinder unit 10 includes the hydraulic pressure booster 31, a master cylinder 32, a regulator 33, and a reservoir 34. The hydraulic pressure booster 31 is connected to the brake pedal 24. The hydraulic pressure booster 31 amplifies a pedal depression force applied to the brake pedal 24, and then transfers the amplified pedal depression force to the master cylinder 32. Thus, the hydraulic fluid is pressurized. The pedal depression force is amplified by supplying the brake fluid from the power hydraulic pressure source 30 to the hydraulic pressure booster 31 through the regulator 33. Then, the master cylinder 32 generates a master cylinder pressure corresponding to a value obtained by amplifying the pedal depression force by predetermined number of times.

The reservoir 34 that stores the brake fluid is provided above the master cylinder 32 and the regulator 33. The master cylinder 32 communicates with the reservoir 34 when the brake pedal 24 is not depressed. The regulator 33 communicates with both the reservoir 34 and an accumulator 35 of the power hydraulic pressure source 30. The regulator 33 generates a fluid pressure that is substantially equal to a value obtained by multiplying the master cylinder pressure by a predetermined ratio, using the reservoir 34 as a low-pressure source and the accumulator 35 as a high-pressure source. Hereinafter, the hydraulic pressure in the regulator 33 will be referred to as “regulator pressure” where appropriate.

The master cylinder unit 10 according to the first embodiment of the invention includes the hydraulic pressure booster 31 and the master cylinder 32. The hydraulic pressure booster 31 serves as a first hydraulic pressure generation unit that generates a hydraulic pressure which assists a force, with which the brake pedal 24 is operated, using the brake fluid that is pressurized in the power hydraulic pressure source 30. The master cylinder 32 is connected to a master pipe 37 that leads to the stroke simulator 69, described later in detail, and generates a hydraulic pressure that corresponds to the sum of the force, with which the brake pedal 24 is operated, and the hydraulic pressure generated in the hydraulic pressure booster 31.

The power hydraulic pressure source 30 includes the accumulator 35 and a pump 36. The accumulator 35 converts the pressure energy of the brake fluid pressurized by the pump 36 into the pressure energy of the filler gas such as nitrogen, for example, the pressure energy having a pressure of approximately 14 MPa to approximately 22 MPa, and stores the pressure energy. The pump 36 has a motor 36a that serves as a drive power source. An inlet of the pump 36 is connected to the reservoir 34, and an outlet thereof is connected to the accumulator 35. The accumulator 35 is connected also to a relief valve 35a provided in the master cylinder unit 10. When the pressure of the brake fluid in the accumulator 35 abnormally increases and becomes, for example, approximately 25 MPa, the relief valve 35a opens, and the brake fluid having a high pressure is returned to the reservoir 34.

As described above, the brake control apparatus 20 includes the master cylinder 32, the regulator 33, and the accumulator 35 that serve as brake fluid supply sources from which the brake fluid is supplied to the wheel cylinders 23. The master pipe 37 is connected to the master cylinder 32. A regulator pipe 38 is connected to the regulator 33. An accumulator pipe 39 is connected to the accumulator 35. The master pipe 37, the regulator pipe 38 and the accumulator pipe 39 are connected to the hydraulic actuator 40.

The hydraulic actuator 40 includes an actuator block having a plurality of passages formed therein, which serve as hydraulic circuits, and a plurality of electromagnetically-controlled valves. Examples of the passages formed in the actuator block include individual passages 41, 42, 43 and 44 and a main passage 45. The individual passages 41, 42, 43 and 44 branch off from the main passage 45, and are connected to the wheel cylinders 23FR, 23FL, 23RR and 23RL of the disc brake units 21FR, 21FL, 21RR and 21RL, respectively. Thus, communication is provided between the wheel cylinders 23 and the main passage 45.

ABS maintaining valves 51, 52, 53 and 54 are provided at the middle portions of the individual passages 41, 42, 43 and 44, respectively. Each of the ABS maintaining valves 51, 52, 53 and 54 includes a solenoid subjected to the ON/OFF control and a spring, and is a normally-open electromagnetically-controlled valve that is open when electric power is not supplied to the solenoid. Each of the ABS maintaining valves 51 to 54 allows the brake fluid to flow in either direction, when it is open. Namely, each of the ABS maintaining valves 51 to 54 allows the brake fluid to flow from the main passage 45 to the wheel cylinder 23, and also allows the brake fluid to flow from the wheel cylinder 23 to the main passage 45. When electric power is supplied to the solenoids and the ABS maintaining valves 51 to 54 are closed, the flow of the brake fluid through the individual passages 41 to 44 is shut off.

In addition, the wheel cylinders 23 are connected to a reservoir passage 55 via pressure-decreasing passages 46, 47, 48 and 49 connected to the individual passages 41, 42, 43 and 44, respectively. ABS pressure-decreasing valves 56, 57, 58 and 59 are provided at the middle portions of the pressure-decreasing passages 46, 47, 48 and 49, respectively. Each of the ABS pressure-decreasing valves 56 to 59 includes a solenoid subjected to the ON/OFF control and a spring, and is a normally-closed electromagnetically-controlled valve that is closed when electric power is not supplied to the solenoid. When the ABS pressure-decreasing valves 56 to 59 are closed, the flow of the brake fluid through the pressure-decreasing passages 46 to 49 is shut off. When electric power is supplied to the solenoids and the ABS pressure-decreasing valves 56 to 59 are opened, the brake fluid flows through the pressure-decreasing passages 46 to 49, and the brake fluid is returned from the wheel cylinders 23 to the reservoir 34 through the pressure-decreasing passages 46 to 49 and the reservoir passage 55. The reservoir passage 55 is connected to the reservoir 34 of the master cylinder unit 10 via a reservoir pipe 77.

A partition valve 60 is provided at the middle portion of the main passage 45. The main passage 45 is partitioned into a first passage 45a that is connected to the individual passages 41 and 42, and a second passage 45b that is connected to the individual passages 43 and 44, when the partition valve 60 is closed. The first passage 45a is connected to the wheel cylinders 23FR and the 23FL for the front wheels via the individual passages 41 and 42, respectively. The second passage 45b is connected to the wheel cylinders 23RR and 23RL for the rear wheels via the individual passages 43 and 44, respectively.

The partition valve 60 includes a solenoid subjected to the ON/OFF control and a spring, and is a normally-closed electromagnetically-controlled valve that is closed when electric power is not supplied to the solenoid. When the partition valve 60 is closed, the flow of the brake fluid through the main passage 45 is shut off. When electric power is supplied to the solenoid and the partition valve 60 is opened, the brake fluid flows between the first passage 45a and the second passage 45b in either direction. That is, the partition valve 60 controls the flow of the hydraulic fluid between the first passage 45a and the second passage 45b.

In the hydraulic actuator 40, a master passage 61 and a regulator passage 62, which communicate with the main passage 45, are formed. More specifically, the master passage 61 is connected to the first passage 45a of the main passage 45, and the regulator passage 62 is connected to the second passage 45b of the main passage 45. The master passage 61 is connected to the master pipe 37 that communicates with the master cylinder 32. The regulator passage 62 is connected to the regulator pipe 38 that communicates with the regulator 33.

A master cut valve 64 is provided at the middle portion of the master passage 61. The master cut valve 64 includes a solenoid subjected to the ON/OFF control and a spring, and is a normally-open electromagnetically-controlled valve that is open when electric power is not supplied to the solenoid. When the master cut valve 64 is open, the brake fluid flows between the master cylinder 32 and the first passage 45a of the main passage 45 in either direction. When electric power is supplied to the solenoid and the master cut valve 64 is closed, the flow of the brake fluid through the master passage 61 is shut off.

A stroke simulator 69 is connected to the master passage 61 via a simulator cut valve 68, at a position upstream of the master cut valve 64. Namely, the simulator cut valve 68 is provided on the passage that connects the master cylinder 32 to the stroke simulator 69. The simulator cut valve 68 includes a solenoid subjected to the ON/OFF control and a spring, and is a normally-closed electromagnetically-controlled valve that is closed when electric power is not supplied to the solenoid. When the simulator cut valve 68 is closed, the flow of the brake fluid through the master passage 61 between the simulator cut valve 68 and the stroke simulator 69 is shut off. When electric power is supplied to the solenoid and the simulator cut valve 68 is opened, the brake fluid flows between the master cylinder 32 and the stroke simulator 69 in either direction.

The stroke simulator 69 includes a plurality of pistons and a plurality of springs. When the simulator cut valve 68 is opened, the stroke simulator 69 generates a reaction force corresponding to the depression force applied to the brake pedal 24 by the driver, using the brake fluid delivered from the master cylinder unit 10. Preferably, a stroke simulator that has multi-stage spring characteristics is used as the stroke simulator 69 in order to improve the brake pedal operating feeling felt by the driver. The stroke simulator 69 according to the first embodiment of the invention has multi-state spring characteristics.

A regulator cut valve 65 is provided at the middle portion of the regulator passage 62. The regulator cut valve 65 also includes a solenoid subjected to the ON/OFF control and a spring, and is a normally-open electromagnetically-controlled valve that is open when electric power is not supplied to the solenoid. When the regulator cut valve 65 is open, the brake fluid flows between the regulator 33 and the second passage 45b of the main passage 45 in either direction. When electric power is supplied to the solenoid and the regulator cut valve 65 is closed, the flow of the brake fluid through the regulator passage 62 is shut off.

In the first embodiment of the invention, the master cylinder 32 of the master cylinder unit 10 is communicated with the wheel cylinders 23FR and 23FL for the front wheels by a first hydraulic circuit that includes elements described below. The first hydraulic circuit includes the master pipe 37, the master passage 61, the first passage 45a of the main passage 45, the individual passages 41 and 41, etc. so that the hydraulic pressure of the brake fluid in the master cylinder unit 10 is transferred to the wheels cylinders 23FR and 23FL for the front wheels. The hydraulic pressure booster 31 and the regulator 33 of the master cylinder unit 10 are communicated with the wheel cylinders 23RR and 23RL for the rear wheels by a second hydraulic circuit that includes elements described below. The second hydraulic circuit includes the regulator pipe 38, the regulator passage 62, the second passage 45b of the main passage 45, the individual passages 43 and 44, etc. so that the hydraulic pressure of the brake fluid in the master cylinder unit 10 is transferred to the wheel cylinders 23RR and 23RL for the rear wheels.

The hydraulic pressure in the master cylinder unit 10, which is boosted in accordance with the amount by which the brake pedal 24 is operated by the driver, is transferred to the wheel cylinders 23FR and 23FL for the front wheels through the first hydraulic circuit. The hydraulic pressure in the master cylinder unit 10 is transferred to the wheel cylinders 23RR and 23RL for the rear wheels through the second hydraulic circuit. Thus, a braking force corresponding to the amount by which the brake pedal 24 is operated by the driver is generated in each wheel cylinder 23. That is, each wheel cylinder 23 applies a braking force to the wheel in response to reception of the brake fluid.

In addition to the master passage 61 and the regulator passage 62, an accumulator passage 63 is formed in the hydraulic actuator 40. One end of the accumulator passage 63 is connected to the second passage 45b of the main passage 45, and the other end thereof is connected to the accumulator pipe 39 that communicates with the accumulator 35.

A pressure-increasing linear control valve 66 is provided at the middle portion of the accumulator passage 63. The accumulator passage 63 and the second passage 45b of the main passage 45 are connected to the reservoir passage 55 via a pressure-decreasing linear control valve 67. Each of the pressure-increasing linear control valve 66 and the pressure-decreasing linear control valve 67 has a linear solenoid and a spring, and is a normally-closed electromagnetically-controlled valve that is closed when electric power is not supplied to the linear solenoid. The opening amounts of the pressure-increasing linear control valve 66 and the pressure-decreasing linear control valve 67 are adjusted in proportion to the magnitudes of electric currents supplied to the respective linear solenoids.

The pressure-increasing linear control valve 66 is shared by the multiple wheel cylinders 23 corresponding to the respective wheels. Similarly, the pressure-decreasing linear control valve 67 is shared by the multiple wheel cylinders 23. Namely, according to the first embodiment of the invention, the pressure-increasing linear control valve 66 and the pressure-decreasing linear control valve 67 are provided as a pair of control valves that are shared by the wheel cylinders 23 and that control the hydraulic fluid supplied from the power hydraulic pressure source 30 to the wheel cylinders 23 and the hydraulic fluid returned from the wheel cylinders 23 to the power hydraulic pressure source 30.

The pressure difference between an inlet and an outlet of the pressure-increasing linear control valve 66 corresponds to the difference between the pressure of the brake fluid in the accumulator 35 and the pressure of the brake fluid in the main passage 45. The pressure difference between an inlet and an outlet of the pressure-decreasing linear control valve 67 corresponds to the difference between the pressure of the brake fluid in the main passage 45 and the pressure of the brake fluid in the reservoir 34. When the electromagnetic drive power corresponding to the electric power supplied to the linear solenoid of each of the pressure-increasing linear control valve 66 and the pressure-decreasing linear control valve 67 is F1, the biasing force of the spring of each of the pressure-increasing linear control valve 66 and the pressure-decreasing linear control valve 67 is F2, and the differential pressure acting force corresponding to the pressure difference between the inlet and the outlet of each of the pressure-increasing linear control valve 66 and the pressure-decreasing linear control valve 67 is F3, the equation, F1+F3=F2, is satisfied. Accordingly, the pressure difference between the inlet and the outlet of each of the pressure-increasing linear control valve 66 and the pressure-decreasing linear control valve 67 is controlled by continuously controlling the electric power supplied to the linear solenoid of each of the pressure-increasing linear control valve 66 and the pressure-decreasing linear control valve 67.

In the first embodiment of the invention, the power hydraulic pressure source 30 is able to deliver the brake fluid that is pressurized by supplied drive power independently of an operation of the brake pedal 24, and is communicated with the wheel cylinders 23 for the front and rear wheels through a third hydraulic circuit that includes elements described below. The third hydraulic circuit includes the accumulator pipe 39, the accumulator passage 63, the main passage 45, the individual passages 41 to 44, etc. so that the hydraulic pressure of the brake fluid in the power hydraulic pressure source 30 is transferred to the wheel cylinders 23.

The hydraulic actuator 40 has the passages described above, and includes the ABS maintaining valves 51 to 54, the ABS pressure-decreasing valves 56 to 59, the partition valve 60, the master cut valve 64, the regulator cut valve 65, the pressure-increasing linear control valve 66, the pressure-decreasing linear control valve 67, the simulator cut valve 68, a regulator pressure sensor 71, an accumulator pressure sensor 72, a control pressure sensor 73, etc. In the hydraulic actuator 40, the passages of the brake fluid that is supplied from at least one of the master cylinder unit 10 and the power hydraulic pressure source 30 are switched based on a control signal from a brake ECU 70. Thus, the hydraulic actuator 40 controls the hydraulic pressure of the hydraulic fluid that is transferred to each wheel cylinder 23.

Because the second passage 45b of the main passage 45 is present between the pressure-increasing linear control valve 66 and the pressure-decreasing linear control valve 67, the hydraulic actuator 40 is able to control the hydraulic pressures in the wheel cylinders 23RR and 23RL for the rear wheels regardless of whether the partition valve 60 is open or closed. When the partition valve 60 is open, the hydraulic actuator 40 is able to control the hydraulic pressures in all the wheel cylinders 23 with the use of the hydraulic pressure of the brake fluid in the power hydraulic pressure source 30.

In the brake control apparatus 20, the power hydraulic pressure source 30 and the hydraulic actuator 40 are controlled by the brake ECU 70 that serves as a controller according to the first embodiment of the invention. The brake ECU 70 is formed of a microprocessor including a CPU. The brake ECU 70 includes, in addition to the CPU, a ROM that stores various programs, a RAM that temporarily stores data, an input port, an output port, a communication port, etc. The brake ECU 70 communicates with a hybrid ECU (not shown), etc. at a higher level. The brake ECU 70 controls the pump 36 of the power hydraulic pressure source 30, the electromagnetically-controlled valves 51 to 54, 56 to 59, 60, and 64 to 68 that form the hydraulic actuator 40 based on control signals from the hybrid ECU and signals from various sensors.

The regulator pressure sensor 71, the accumulator pressure sensor 72, and the control pressure sensor 73 are connected to the brake ECU 70. The regulator pressure sensor 71 is provided upstream of the regulator cut valve 65. The regulator pressure sensor 71 detects the pressure of the brake fluid in the regulator passage 62, namely, the regulator pressure, and transmits a signal indicating the detected regulator pressure to the brake ECU 70. The accumulator pressure sensor 72 is provided upstream of the pressure-increasing linear control valve 66. The accumulator pressure sensor 72 detects the pressure of the brake fluid in the accumulator passage 63, namely, the accumulator pressure, and transmits a signal indicating the detected accumulator pressure to the brake ECU 70. The control pressure sensor 73 detects the pressure of the brake fluid in the first passage 45a of the main passage 45, and transmits a signal indicating the detected brake fluid pressure to the brake ECU 70. The signals indicating the values detected by the regulator pressure sensor 71, the accumulator pressure sensor 72, and the control pressure sensor 73 are transmitted to the braked ECU 70 at predetermined time intervals, and stored in a predetermined storage region of the brake ECU 70. In the first embodiment of the invention, the regulator pressure sensor 71, the accumulator pressure sensor 72, and the control pressure sensor 73 each has self-checking function. Therefore, these sensors individually determine whether a malfunction has occurred therein, and transmit a signal indicating presence or absence of a malfunction to the ECU 70.

When the partition valve 60 is open and the first passage 45a and the second passage 45b of the main passage 45 communicate with each other, the value output from the control pressure sensor 73 indicates the lower hydraulic pressure at the pressure-increasing linear control valve 66 and the higher hydraulic pressure at the pressure-decreasing linear control valve 67. Accordingly, the value output from the control pressure sensor 73 is used to control the pressure-increasing linear control valve 66 and the pressure-decreasing linear control valve 67. When the pressure-increasing linear control valve 66 and the pressure-decreasing linear control valve 67 are both closed and the master cut valve 64 is open, the value output from the control pressure sensor 73 indicates the master cylinder pressure. When the partition valve 60 is open and the first passage 45a and the second passage 45b of the main passage 45 communicate with each other, and the ABS maintaining valves 51 to 54 are open while the ABS pressure-decreasing valves 56 to 59 are closed, the value output from the control pressure sensor 73 indicates the hydraulic fluid pressure that is applied to each of the wheel cylinders 23, namely, the wheel cylinder pressure.

Examples of the sensors that are connected to the brake ECU 70 include a stroke sensor 25 fitted to the brake pedal 24. The stroke sensor 25 detects a brake pedal stroke that is an operation amount of the brake pedal 24, and transmits a signal indicating the detected brake pedal stroke to the brake ECU 70. The value output from the stroke sensor 25 is transmitted to the brake ECU 70 at predetermined time intervals, and stored in a predetermined storage region of the brake ECU 70.

The brake control apparatus 20 structured as described above may be placed in one of at least three control modes, that are, a cooperative braking control mode, a Reg mode, and a hydro-booster mode. When the vehicle is traveling in a normal state, the brake control apparatus 20 controls a braking force in the cooperative braking control mode. For example, when an examination of each sensor is made or when antilock control (hereinafter, referred to as “ABS control” where appropriate) is executed while the vehicle is not moving, the brake control apparatus 20 controls a braking force in the Reg mode. If it is determined that a malfunction has occurred in the brake control apparatus 20, the brake control apparatus 20 controls a braking force in the hydro-booster mode. In the hydro-booster mode, the hydraulic pressure in accordance with the amount by which the brake pedal 24 is operated by the driver is transferred to the wheel cylinders 23 to generate braking forces.

In either case, the brake control apparatus 20 starts a brake operation upon reception of a braking command. A braking command is issued when a braking force needs to be applied to the vehicle. A braking command is issued, for example, when the driver operates the brake pedal 24 or when the distance between the vehicle and another vehicle falls below a predetermined distance while the distance between the moving vehicle and the other vehicle is automatically controlled

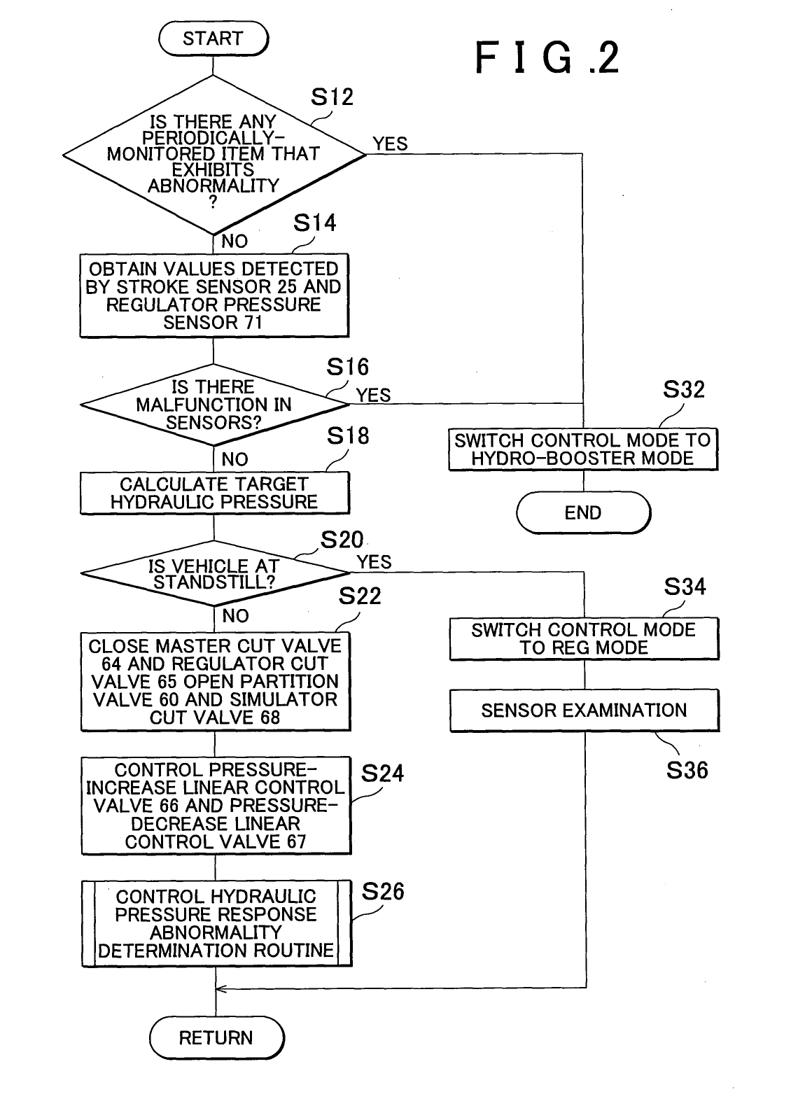

FIG. 2 is a flowchart for describing a control routine that is executed in the cooperative braking control mode. In the cooperative braking control mode, the cooperative braking control is executed. The routine shown in FIG. 2 is periodically executed at predetermined time intervals of, for example, several milliseconds after a braking command is issued in response to an operation of the brake pedal 24.

When the control routine in the cooperative braking control mode is started, the brake ECU 70 first determines whether there is any periodically-monitored item that exhibits an abnormality (S12). Examples of the periodically-monitored items include presence or absence of breakage of a wire in the brake control apparatus 20, presence or absence of a short-circuit within the brake control apparatus 20, and presence or absence of a malfunction in the power hydraulic pressure source 30 that is determined based on a value detected by the accumulator pressure sensor 72.

If it is determined that there is a periodically-monitored item that exhibits an abnormality (“YES” in S12), the brake ECU 70 switches the control mode from the cooperative braking control mode to the hydro-booster mode to terminate the cooperative braking control (S32). On the other hand, if it is determined that there is no periodically-monitored item that exhibits an abnormality (“NO” in S12), the brake ECU 70 obtains the values detected by the stroke sensor 25 and the regulator pressure sensor 71 (S14). The operation amount of the brake pedal 24 is detected by the stroke sensor 25, and the hydraulic pressure in the master cylinder 10, which has been boosted due to depression of the brake pedal 24, is detected by the regulator pressure sensor 71.

Next, the brake ECU 70 determines whether a malfunction has occurred in the stroke sensor 25 and whether a malfunction has occurred in the regulator pressure sensor 71 based on the value detected by the stroke sensor 25 and the value detected by the regulator pressure sensor 71 (S16). In the first embodiment of the invention, two stroke sensors 25 are provided in parallel. The brake ECU 70 compares the value detected by one of the stroke sensors 25, the value detected by the other stroke sensor 25, and the value detected by the regulator pressure sensor 71 with each other to determine whether there is a sensor that has detected an abnormal value. If the value detected by one of these sensors is abnormally different from the values detected by the other two sensors, the brake ECU 70 determines that a malfunction has occurred in the sensor that has detected the abnormal value. If it is determined that a malfunction has occurred in one of these sensors (“YES” in S16), the brake ECU 70 switches the control mode from the cooperative braking control mode to the hydro-booster mode to terminate the cooperative braking control (S32).

On the other hand, if it is determined that a malfunction has occurred in neither the stroke sensors 25 nor the regulator pressure sensor 71 (“NO” in S16), the brake ECU 70 calculates a target hydraulic pressure for the wheel cylinder 23 (S18). In this case, the brake ECU 70 first subtracts a regenerative braking force from a total required braking force to calculate a required hydraulic braking force that is a braking force which should be generated by the brake control apparatus 20. In this case, a signal indicating the regenerative braking force is transmitted from the hybrid ECU to the brake control apparatus 20. Then, the brake ECU 70 calculates the target hydraulic pressure for the wheel cylinder 23 based on the calculated required hydraulic braking force.

Next, the brake ECU 70 determines whether the vehicle is at a standstill (S20). If it is determined that the vehicle is already at a standstill (“YES” in S20), the brake ECU 70 switches the control mode from the cooperative braking control mode to the Reg mode (S34), and makes a sensor examination (S36). In the sensor examination, the brake ECU 70 compares the value detected by the control pressure sensor 73, the value detected by the regulator pressure sensor 71, and the values detected by the stroke sensors 25 with each other to examine whether each of these sensors is operating properly.

It is not necessary to switch the control mode to the Reg mode to make a sensor examination every time it is determined that the vehicle is at a standstill. For example, a sensor examination may be made with appropriate frequency, for example, once per several brake operations. The routine shown in FIG. 2 is completed when the sensor examination is completed, and executed again in the same manner when next execution timing is reached.

On the other hand, if it is determined that the vehicle is moving (“NO” in S20), the brake ECU 70 places the master cut valve 64 and the regulator cut valve 65 in a closed state and partition valve 60 and the simulator cut valve 68 in an open state (S22). Thus, the wheel cylinders 23 are shut off from the master cylinder unit 10 and allowed to be supplied with the brake fluid from the power hydraulic pressure source 30. Also, the brake fluid, which is delivered from the master cylinder 32 in response to a brake operation performed by the driver, is supplied to the stroke simulator 69, and a reaction force corresponding to a depression force applied to the brake pedal 24 by the driver is generated. As a result, the brake feel felt by the driver is appropriately maintained.

In this state, the brake ECU 70 controls the pressure-increasing linear control valve 66 and the pressure-decreasing linear control valve 67 based on the target hydraulic pressure (S24). More specifically, the brake ECU 70 controls electric currents that are supplied to these valves 66 and 67 to control the opening amounts thereof. Then, the brake ECU 70 executes a control hydraulic pressure response abnormality determination routine in which it is determined whether the hydraulic pressures in the wheel cylinders 23 are appropriately controlled (S26). In this routine, it is determined whether the wheel cylinder pressures are appropriately controlled based on the value detected by the control pressure sensor 73. The routine shown in FIG. 2 is completed when the routine in S26 is completed, and executed again in the same manner when next executing timing is reached.

As described above, in the cooperative braking control mode, the brake fluid that is delivered from the power hydraulic pressure source 30 is supplied to the wheel cylinders 23 via the pressure-increasing linear control valve 66, whereby braking forces are applied to the wheels. Alternatively, the brake fluid is returned from the wheel cylinders 23 to the power hydraulic pressure source 30 via the pressure-decreasing linear control valve 67, whereby the braking forces that are applied to the wheels are controlled.

In contrast, in the Reg mode and the hydro-booster mode, the hydraulic pressure in the master cylinder unit 10, which has been boosted in response to a brake operation performed by the driver, is transferred to the wheel cylinders 23. In the Reg mode, the brake ECU 70 places the regulator cut valve 65, the partition valve 60 and the simulator cut valve 68 in the open state and the master cut valve 64 in the closed state. As a result, the regulator pressure is transferred to the wheel cylinders 23, whereby braking forces are applied to the wheels. At this time, the brake fluid that is delivered from the master cylinder 32 is supplied to the stroke simulator 69.

In the Reg mode, because fluctuations in the hydraulic pressure in the wheel cylinders 23 are not transferred to the master cylinder 32, the driver feels good brake feel. In addition, because the same control hydraulic pressure is applied to the control pressure sensor 73 and the regulator pressure sensor 71, the sensor examination is made with higher accuracy.

In the hydro-booster mode, the brake ECU 70 places the master cut valve 64 and the regulator cut valve 65 in the open state and the partition valve 60 and the simulator cut valve 68 in the closed state. As a result, the master cylinder pressure is transferred to the wheel cylinders 23FR and 23FL for the front wheels through the first hydraulic circuit, and the regulator pressure is transferred to the wheel cylinders 23RR and 23RL for the rear wheels through the second hydraulic circuit. Thus, braking forces are applied to the wheels.

In the first embodiment of the invention, as described above, the hydro-booster mode is used as an extra control mode that is used when the cooperative braking control is not executed due to, for example, occurrence of a malfunction. In the hydro-booster mode, the first hydraulic circuit and the second hydraulic circuit are separated from each other by placing the partition valve 60 in the closed state. With this configuration, even if a further malfunction, for example, leakage of liquid from a pipe, occurs in one of the hydraulic circuits, braking forces are applied with the use of the other hydraulic circuit that is operating properly. As described above, provision of the partition valve enhances the safety.

When the control modes are switched in the brake control apparatus 20 that has multiple control modes, some drivers feel a sense of discomfort due to a change in the characteristics of the braking force. In the brake control apparatus 20 according to the first embodiment of the invention, if it is determined that the value detected by the accumulator pressure sensor 72 falls below a reference low pressure that is set to determine whether the pressure in the power hydraulic pressure source 30 is abnormally low, it is determined in S12 shown in FIG. 2 that there is a periodically-monitored item that exhibits an abnormality (“YES” in S12). In this case, the brake ECU 70 switches the control mode from the cooperative braking control mode to the hydro-booster mode to terminate the cooperative braking control. Because such switching of the control modes deteriorates the brake feel, it should be avoided as much as possible.

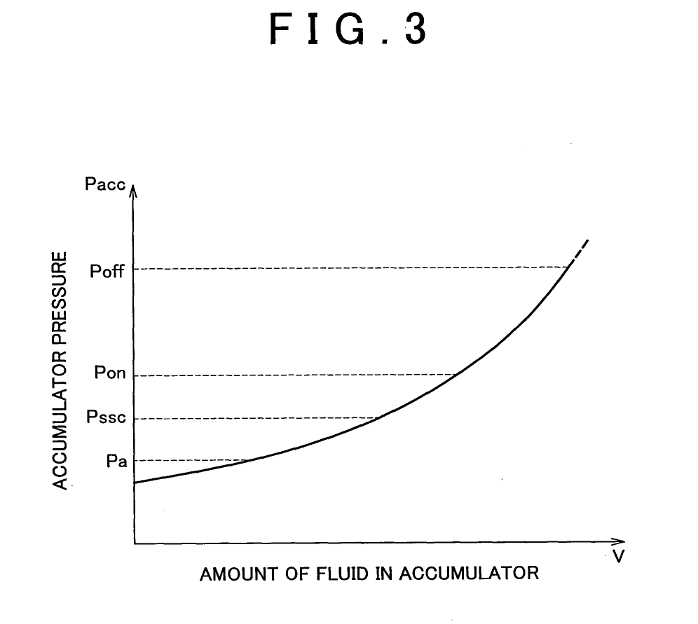

Therefore, description will be provided concerning a technology for suppressing switching of the control modes due to a pressure decrease in the hydraulic pressure source 30, particularly, in the accumulator 35 according to the first embodiment of the invention. FIG. 3 is a graph showing the relationship between the amount of brake fluid in the accumulator 35 and the pressure accumulated in the accumulator 35.

In the accumulator 35, an accumulator pressure Pacc is boosted to a pump stop pressure Poff by the pump 36 that is driven by the motor 36a. If the brake fluid in the accumulator 35 is delivered to transfer the hydraulic pressure that is needed in the wheel cylinders to apply brakes to the vehicle, the amount of brake fluid in the accumulator decreases and the pressure in the accumulator gradually decreases. Therefore, if the accumulator pressure Pacc decreases to a pump operation pressure Pon, the pump 36 starts operating and accumulation of the pressure in the accumulator 35 is started. Accordingly, the accumulator pressure Pacc usually undergoes a transition within a range between the pump stop pressure Poff and the pump operation pressure Pon.

However, if the pressure continues to decrease for some reason although the accumulator pressure Pacc falls below the pump operation pressure Pon, and the pressure reaches a reference low pressure Pa, it is estimated that some sort of malfunction has occurred in the power hydraulic pressure source 30 and the control mode is switched from the cooperative braking control mode to the hydro-booster mode. The reference low pressure Pa may be regarded as the minimum hydraulic pressure that is required to apply brakes to the vehicle mainly with the use of the power hydraulic pressure source 30.

Examples of such reason may include a problem that a sufficient amount of brake fluid is not delivered to the accumulator 35 due to a malfunction in the pump 36 or the motor 36a, and so-called pumping brake, that is, repeated depression of the brake pedal 24 within a short time. Therefore, the manner in which the brake fluid in the accumulator is consumed due to pumping brake will be described.

If pumping brake is performed during the cooperative braking control mode, it is determined that a braking command has been issued based on an output from, for example, the stroke sensor 25, and the master cut valve 64 and the regulator cut valve 65 are closed and the partition valve 60 and the simulator cut valve 68 are opened. Then, the brake control apparatus 20 controls the pressure-increasing linear control valve 66 and the pressure-decreasing linear control valve 67 to adjust the amount of brake fluid that is delivered from the accumulator 35 of the power hydraulic pressure source 30 to the wheel cylinders 23. As a result, appropriate braking forces are applied to the wheels.

Because the simulator cut valve 68 is open, the brake fluid that is delivered from the master cylinder 32 in response to an operation of the brake pedal 24 flows into the stroke simulator 69, and a reaction force corresponding to the operation of the brake pedal 24 is generated.

At this time, because the brake fluid that flows into the stroke simulator 69 is delivered from the master cylinder 32 of the master cylinder unit 10, the volume of the master cylinder 32 decreases. In accordance with this, the brake pedal 24 is moved by an operating force applied by the driver and the volume of the hydraulic pressure booster 31 that assists the operating force applied to the brake pedal 24 with the use of the hydraulic pressure increases. The accumulator 35 is communicated with the hydraulic pressure booster 31 via the regulator 33. Therefore, if the hydraulic pressure in the hydraulic pressure booster 31 decreases, the brake fluid is delivered to compensate for the decrease.

Then, when the operation of the brake pedal 24 is cancelled, the master cut valve 64 and the regulator cut valve 65 are opened and the stroke simulator valve 69 is closed. Therefore, the brake fluid in the master passage 61 and the regulator passage 62 flow downstream of the master cut valve 64 and the regulator cut valve 65, and returned to the reservoir.

If such a braking command is issued, the power hydraulic pressure source 30 delivers the brake fluid not only to the wheel cylinders 23 through the accumulator pipe 39 but also to the regulator 33 and the hydraulic pressure booster 31. Therefore, particularly, when pumping brake is performed, the amount of brake fluid that is delivered from the accumulator 35 increases, because the brake pedal 24 is repeatedly depressed in a short time. It is therefore predicted that the amount of brake fluid that is delivered from the accumulator 35 exceeds the amount of brake fluid that is delivered to the accumulator 35 by the pump 36.

In this case, if the hydraulic pressure of the brake fluid in the power hydraulic pressure source 30 falls below the reference low pressure Pa that is the minimum hydraulic pressure required to execute the cooperative braking control mode in which the power hydraulic pressure source 30 is mainly used as the hydraulic pressure supply source, the brake control apparatus 20 switches the control mode to the hydro-booster mode in which the hydraulic actuator 40 is controlled in such a manner that the brake fluid that is supplied from the master cylinder unit 10 through the master passage 61 and the regulator passage 62 is delivered to the wheel cylinders 23. If the supply source of the brake fluid that transfers the hydraulic pressure when brakes are applied to the vehicle is switched from the power hydraulic pressure source 30 to the master cylinder unit 10, the driver may feel unusual brake feel.

Therefore, a method for suppressing switching of the control modes according to the first embodiment of the invention will be described. According to this method, a change in the volume of the master cylinder 32 is suppressed by suppressing the amount of brake fluid that flows into the stroke simulator 69, the amount of brake fluid that flows into the hydraulic pressure booster 31 is decreased, and the amount of brake fluid that is delivered from the accumulator 35 is decreased.

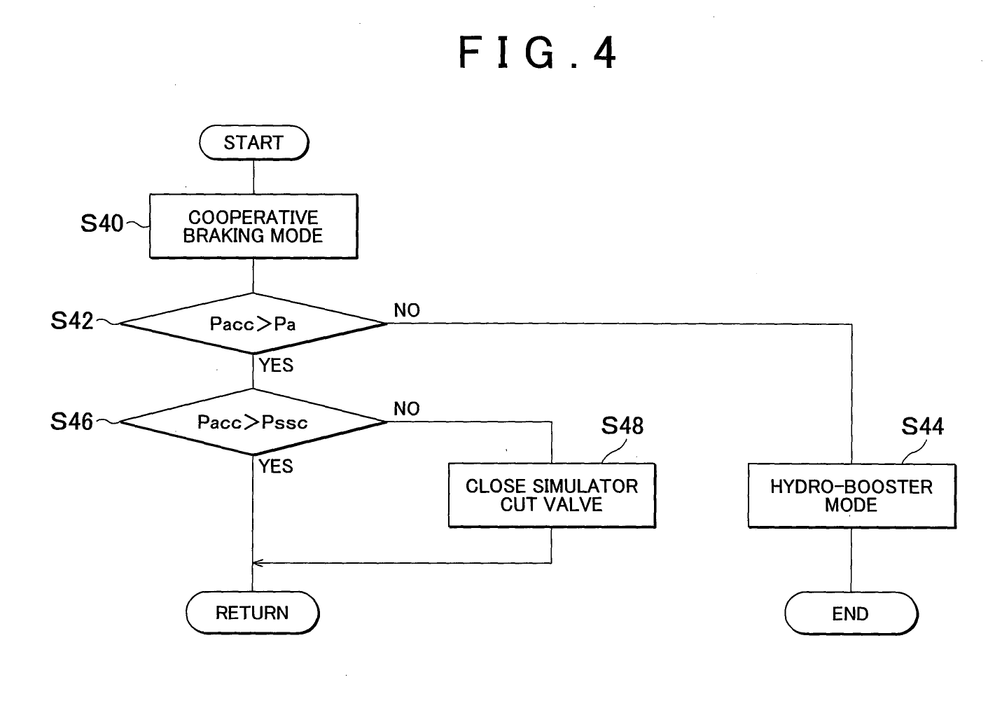

FIG. 4 is a flowchart for describing a routine for suppressing the amount of brake fluid that flows into the stroke simulator according to the first embodiment of the invention. When a braking command is issued in response to an operation of the brake pedal 24, the cooperative braking control mode is performed (S40). In the cooperative braking control mode, the hydraulic pressure that is transferred to the wheel cylinders 23 is controlled by the hydraulic actuator 40 with the use of the hydraulic pressure of the brake fluid in the power hydraulic pressure source 30 under a predetermined condition. Then, the brake ECU 70 obtains the accumulator pressure Pacc from the accumulator pressure sensor 72 at predetermined intervals, and compares the accumulator pressure Pacc with the reference low pressure Pa (S42). If it is determined that the accumulator pressure Pacc is lower than the reference low pressure Pa (“NO” in S42), the brake ECU 70 determines that some sort of malfunction has occurred in the power hydraulic pressure source 30, and switches the control mode to the hydro-booster mode (S44), after which the cooperative braking control is terminated.

If it is determined that the accumulator pressure Pacc is higher than the reference low pressure Pa (“YES” in S42), it is determined whether the accumulator pressure Pacc is higher than a simulator cut valve closing pressure Pssc (S46). The simulator cut valve closing pressure Pssc is empirically determined in consideration of a decrease in the stroke amount of the brake pedal 24 due to closing of the simulator cut valve 68 and a decrease in the accumulator pressure Pacc caused by an increase in the brake fluid that is supplied to the stroke simulator 69 due to opening of the simulator cut valve 68. The simulator cut valve closing pressure Pssc in the first embodiment of the invention is set to a value that is lower than the pump operation pressure Pon and higher than the reference low pressure Pa.

If it is determined that the accumulator pressure Pacc is higher than the simulator cut pressure Pssc (“YES” in S46), the brake ECU 70 ends the routine. On the other hand, if it is determined that the accumulator pressure Pacc is equal to or lower than the simulator cut pressure Pssc (“NO” in S46), the brake ECU 70 closes the simulator cut valve 68 (S48). Thus, the brake fluid is prevented from flowing into the stroke simulator 69, and therefore the amount of brake fluid that is delivered from the master cylinder 32 is decreased. Accordingly, a change in the volume in the master cylinder 32 is suppressed. Therefore, a change in the volume in the hydraulic pressure booster 31 is also suppressed, and the amount of brake fluid that is delivered from the power hydraulic pressure source 30 to the hydraulic pressure booster 31 is decreased. Accordingly, a decrease in the pressure of the brake fluid that is pressurized in the power hydraulic pressure source 30 is suppressed. As a result, it is possible to suppress switching of the supply source of the brake fluid, which transfers the hydraulic pressure when brakes are applied to the vehicle, from the power hydraulic pressure source 30 to the master cylinder unit 10. As a result, the brake feel is enhanced.

Hereinafter, a second embodiment of the invention will be described. In the first embodiment of the invention, the brake ECU 70 controls the open/closed state of the simulator cut valve 68 based on the value detected by the accumulator pressure sensor 72. Alternatively, the brake ECU 70 controls the open/closed state of the simulator cut valve 68 based on an ON signal and an OFF signal from the stroke sensor 25 according to the second embodiment of the invention.

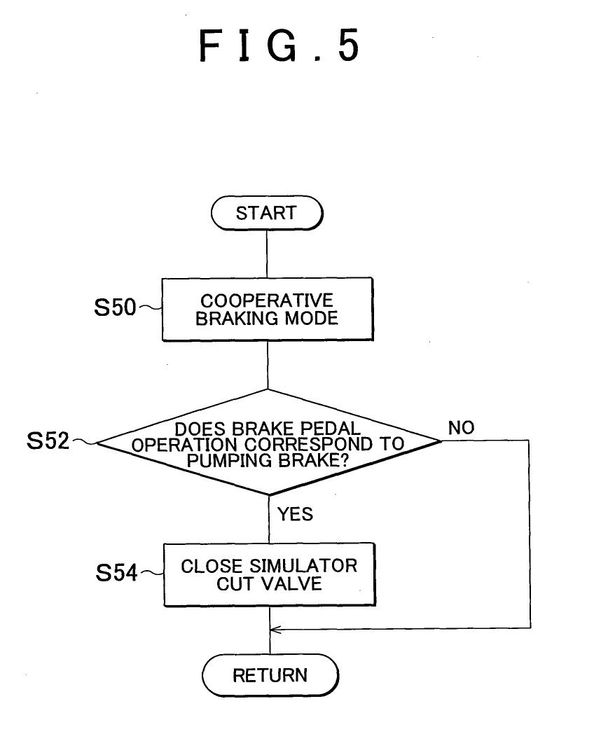

FIG. 5 is a flowchart for describing a routine for suppressing the amount of brake fluid that flows into the stroke simulator according to the second embodiment of the invention. When a braking command is issued in response to an operation of the brake pedal 24, the cooperative braking control mode is executed under a predetermined condition (S50). Then, the brake ECU 70 determines whether the operation of the brake pedal 24 corresponds to pumping brake based on the number of times the brake pedal 24 is operated, which is detected based on ON signals and OFF signals detected by the stroke sensor 25 (S52). Whether the operation of the brake pedal 24 corresponds to pumping brake is determined based on whether the number of times the brake pedal 24 is operated within a predetermined period is equal to or larger than the predetermined number of times. The predetermined number of times is empirically determined in consideration of the extent to which the brake fluid can be pressurized in the power hydraulic pressure source 30 with the use of supplied drive power and the amount of brake fluid that is delivered from the power hydraulic pressure source 30 in response to each operation of the brake pedal 24.

If it is determined that the operation of the brake pedal 24 does not correspond to pumping brake (“NO” in S52), it is estimated that a decease in the hydraulic pressure of the brake fluid in the power hydraulic pressure source 30 is not considerably large and the necessity to restrict the flow of the brake fluid into the stroke simulator 69 is not great. Therefore, the routine ends without closing the simulator cut valve 68. On the other hand, if it is determined that the operation of the brake pedal 24 corresponds to pumping brake (“YES” in S52), the brake ECU 70 closes the simulator cut valve 68 (S54). Thus, it is possible to suppress a decrease in the pressure of the brake fluid that is pressurized in the power hydraulic pressure source 30, as in the first embodiment of the invention. As a result, it is possible to suppress switching of the supply source of the brake fluid, which transfers the hydraulic pressure when brakes are applied to the vehicle, from the power hydraulic pressure source 30 to the master cylinder unit 10, thereby enhancing the brake feel. In addition, even if a malfunction has occurred in the accumulator pressure sensor 72, it is possible to determine whether the simulator cut valve 68 should be closed based only on a signal from the stroke sensor 25.

According to the second embodiment of the invention, the control on the open/closed state of the simulator cut valve 68 is executed based on a determination as to whether an operation of the brake pedal 24 corresponds to pumping brake. According to the first embodiment of the invention, the control on the open/closed state of the simulator cut valve 68 is executed based on the accumulator pressure. The control according to the second embodiment of the invention may be executed in combination with the control according to the first embodiment of the invention. Thus, it is possible to more accurately suppress a decrease in the hydraulic pressure of the brake fluid in the power hydraulic pressure source 30.

Hereinafter, a third embodiment of the invention will be described. In the first and second embodiments of the invention, the simulator cut valve 68 is closed when it is estimated that the degree of decrease in the accumulator pressure is large. Therefore, a reaction force is not generated in the stroke simulator 69, and a pedal stroke that feels natural to the driver cannot be obtained depending on the timing for closing the simulator cut valve 68. Therefore, according to the third embodiment of the invention, when it is estimated that the degree of decrease in the accumulator pressure is large, the timing for closing the simulator cut valve 68 is appropriately corrected.

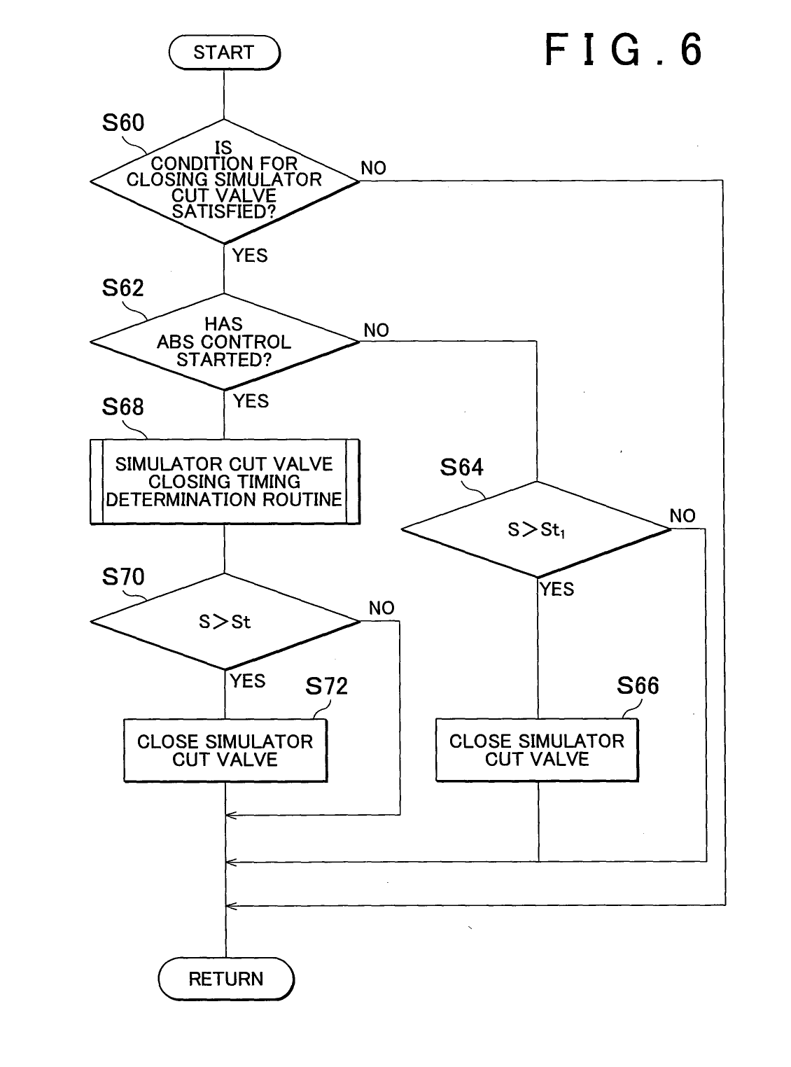

FIG. 6 is a flowchart for describing a routine for determining the timing for closing the simulator cut valve 68 according to the third embodiment of the invention. First, it is determined whether a condition for closing the simulator cut valve 68 is satisfied (S60). Whether the simulator cut valve 68 should be closed is determined based on, for example, whether the accumulator pressure Pacc is higher than the simulator cut pressure Pssc or whether the number of times the brake pedal 24 is operated within the predetermined period is larger than the predetermined number of times.

If it is determined that the condition for closing the simulator cut valve 68 is not satisfied (“NO” in S60), the brake ECU 70 ends the routine. On the other hand, if it is determined that the condition for closing the simulator cut valve 68 is satisfied (“YES” in S60), it is determined whether the ABS control has already been started (S62). For example, the brake ECU 70 calculates a speed, deceleration, etc., of each wheel based on signals from wheel sensors (not shown) that detect the speeds of the wheels, and estimates a vehicle body speed and a slip ratio. Then, if the slip ratio reaches a predetermined value, the ABS control is executed.

If it is determined that the ABS control has not been started (“NO” in S62), it is determined whether a stroke amount S that is detected by the stroke sensor 25 is larger than a predetermined permissible stroke amount St1 that is used during regular braking control in which the ABS control is not executed (S64). If it is determined that the stroke amount S that is detected by the stroke sensor 25 is equal to or smaller than the predetermined permissible stroke amount St1 (“NO” in S64), the brake ECU 70 ends the routine without closing the simulator cut valve 68. On the other hand, if the stroke amount S that is detected by the stroke sensor 25 is larger than the predetermined permissible stroke amount St1 (“YES” in S64), the brake ECU 70 closes the simulator cut valve 68 (S66). Thus, the brake pedal 24 can be operated by a predetermined stroke amount in a period from when an operation of the brake pedal 24 is started until when the simulator cut valve 68 is closed. Accordingly, it is possible to reduce unusual brake feel that is felt by the driver when the simulator cut valve 68 is closed. The permissible stroke amount St1 is set to a value within such a range that a decrease in the accumulator pressure caused by the brake fluid that flows into the stroke simulator 69 is permissible.

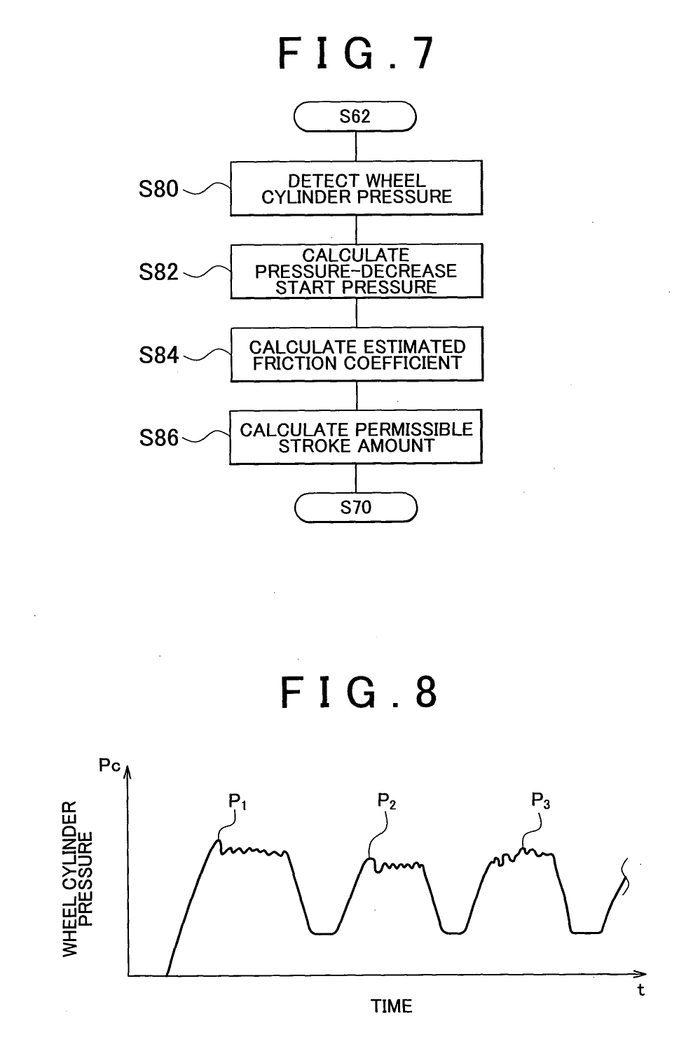

If it is determined that the ABS control has already been started (“YES” in S62), the control mode is switched to the Reg mode described above, and a simulator cut valve closing timing determination routine is started (S68). FIG. 7 is a flowchart showing the details of the simulator cut valve closing timing determination routine.

After the ABS control is started, the driver feels brake feel that differs from the brake feel which is felt by the driver during the regular braking control. Accordingly, the necessity to generate a reaction force with the use of the stroke simulator 69 is reduced. Meanwhile, the magnitude of braking force at which the ABS control is started and the timing for starting the ABS control vary depending on a road surface condition. Therefore, during the ABS control, the timing for closing the simulator cut valve 68 is changed based on the road surface condition. In this way, it is possible to suppress unusual brake feel that is felt by the driver when the simulator cut valve 68 is closed, while suppressing the amount of brake fluid that is consumed in the stroke simulator 69. Accordingly, the brake ECU 70 according to the third embodiment of the invention is provided with a road surface condition estimation unit that estimates a road surface condition that is correlated with slip of the wheel after the ABS control is started. The road surface condition estimation unit estimates a coefficient of friction between the wheel and the road surface by executing a routine described below.

When the simulator cut valve closing timing determination routine is started, a change in the wheel cylinder pressure is continuously detected based on the value detected by the control pressure sensor 73 (S80). FIG. 8 is a graph showing a temporal change in the wheel cylinder pressure during the ABS control. After the ABS control is started, the hydraulic pressure in the wheel cylinder 23 is increased, maintained, and then decreased repeatedly by the operations of the ABS maintaining valve and the ABS pressure-decreasing valve. In this case, a pressure-decrease start pressure Pd may be obtained by calculating an average pressure in the period in which the wheel cylinder pressure is stabilized to some extent. The pressure-decrease start pressure Pd corresponds to the road surface condition, for example, a friction coefficient μ, which is a coefficient of friction between the wheel (tire) and the road surface.

That is, if the pressure-decrease start pressure Pd is high, the amount of slip increases in the state in which a braking force is large. Therefore, it is estimated that the friction coefficient μ is large. On the other hand, if the pressure-decrease start pressure Pd is low, the amount of slip is increased from when the braking force is small. Therefore, it is estimated that the friction coefficient μ is small. In the third embodiment of the invention, the pressure-decrease start pressure Pd is obtained by calculating the average of P1, P2 and P3 shown in FIG. 8. In this way, the brake ECU 70 calculates the pressure-decrease start pressure Pd based on a change in the wheel cylinder pressure (S82).

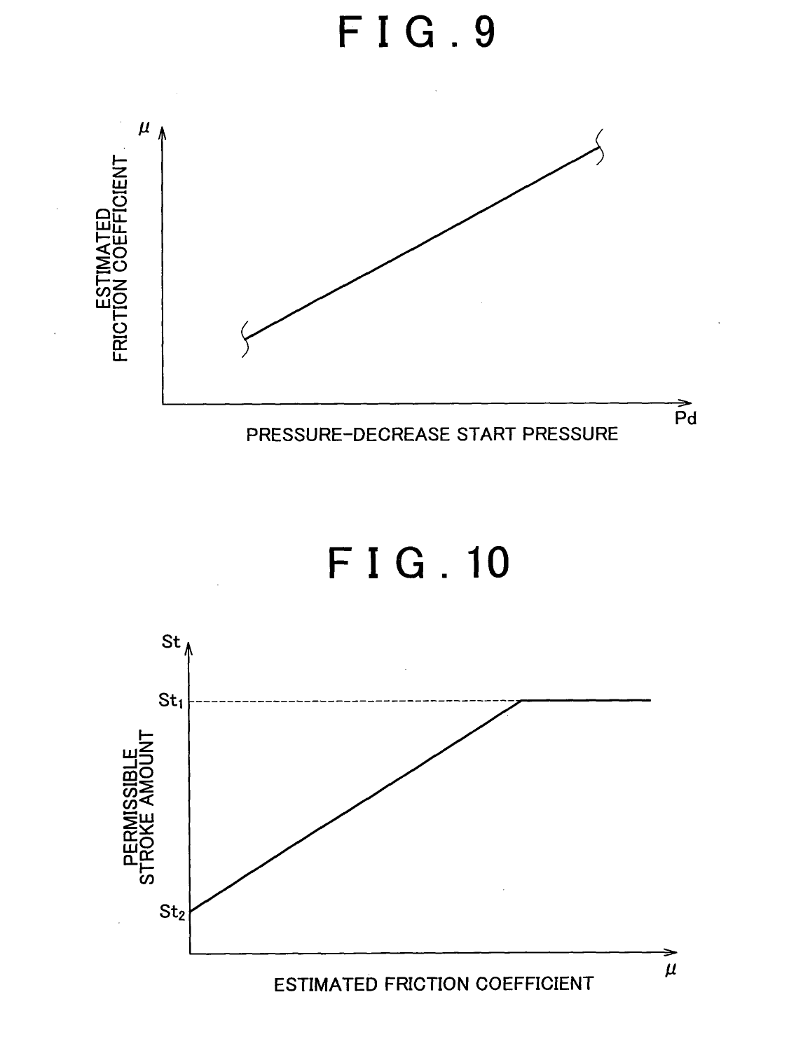

FIG. 9 is a graph showing the relationship between the pressure-decrease start pressure Pd and the estimated friction coefficient μ. The brake ECU 70 calculates the estimated friction coefficient μ, which is a coefficient of friction between the tire and the road surface, based on the pressure-decrease start pressure Pd with reference to a table or a map which contains the relationship shown in FIG. 9 (S84).

FIG. 10 is a graph showing the relationship between the estimated friction coefficient and a permissible stroke amount, which is a stroke amount that is permitted to be achieved in a period until the simulator cut valve 68 is closed. As shown in FIG. 10, when the estimated friction coefficient μ is low, the permissible stroke amount St is set to a low value because the ABS control is started in the state in which the operation amount of the brake pedal 24 is small and the wheel cylinder pressure is low (St=St2). As the estimated friction coefficient μ increases, the permissible stroke amount St is gradually increased because the ABS control is started in the state in which the operation amount of the brake pedal 24 is larger and the wheel cylinder pressure is higher (St2<St<St1). When the estimated friction coefficient μ exceeds a predetermined value, the ABS control is not executed or the control amount is small even if the ABS control is executed. Therefore, the permissible stroke amount St is constantly maintained at St1. The brake ECU 70 calculates the permissible stroke amount St based on the relationship shown in FIG. 10 (S86).

Then, as shown in FIG. 7, the brake ECU 70 compares the permissible stroke amount St that is calculated based on the estimated friction coefficient μ and the stroke amount S that is detected by the stroke sensor 25 with each other (S70). If it is determined that the stroke amount S that is detected by the stroke sensor 25 is equal to or smaller than the permissible stroke amount St (“NO” in S70), the brake ECU 70 ends the routine without closing the simulator cut valve 68. On the other hand, if it is determined that the stroke amount S that is detected by the stroke sensor 25 is larger than the permissible stroke amount St (“YES” in S70), the brake ECU 70 closes the simulator cut valve 68 (S72). Thus, the brake ECU 70 changes the timing for closing the simulator cut valve 68 based on the road surface condition during the ABS control. In this way, it is possible to suppress uncomfortable brake feel that is felt by the driver when the simulator cut valve 68 is closed, while suppressing the amount of hydraulic fluid that is consumed in the stroke simulator 69.

In brake control apparatus 20 according to the third embodiment of the invention, the coefficient of friction between the wheel and the road surface is estimated based on the pressure-decrease start pressure Pd. Therefore, when the friction coefficient is large and the stroke amount of the brake pedal 24 that is achieved in a period until the ABS control is started is large, the stroke amount of the brake pedal 24 that is achieved in a period until the simulator cut valve 68 is closed is increased. On the other hand, when the friction coefficient is low and the stroke amount of the brake pedal 24 that is achieved in a period until the ABS control is started is small, the stroke amount of the brake pedal 24 that is achieved in the period until the simulator cut valve 68 is closed is decreased.

Even in the Reg mode, for example, during the ABS control, a decrease in the brake fluid pressure in the power hydraulic pressure source 30 is suppressed by closing the simulator cut valve at appropriate timing. As a result, it is possible to prevent switching of the control mode to the hydro-booster mode.

While the invention has been described with reference to example embodiments thereof, it is to be understood that the invention is not limited to the example embodiments or constructions. To the contrary, the invention is intended to cover various modifications and equivalent arrangements. In addition, while the various elements of the example embodiments are shown in various combinations and configurations, which are exemplary, other combinations and configurations, including more, less or only a single element, are also within the scope of the invention.

1. A brake control apparatus that controls a braking force which is applied to a wheel based on a hydraulic pressure of a hydraulic fluid, comprising:
a manual hydraulic pressure source that pressurizes the hydraulic fluid based on an amount by which a brake operation member is operated by a driver;
a power hydraulic pressure source that is able to deliver the hydraulic fluid pressurized by supplied drive power independently of any operations of the brake operation member;
a pressure sensor that detects the hydraulic pressure of the hydraulic fluid pressurized in the power hydraulic pressure source;
a hydraulic circuit which connects the manual hydraulic pressure source and the power hydraulic pressure source to a wheel cylinder that applies a braking force to the wheel, and in which a passage is formed so that the hydraulic pressure of the hydraulic fluid in the manual hydraulic pressure source and the hydraulic pressure of the hydraulic fluid in the power hydraulic pressure source are transferred to the wheel cylinder;
a pressure control mechanism that switches a passage through which the hydraulic fluid that is supplied from at least one of the manual hydraulic pressure source and the power hydraulic pressure source flows, thereby controlling the hydraulic pressure of the hydraulic fluid that is transferred to the wheel cylinder;
a stroke simulator that is connected to the hydraulic circuit and that generates a reaction force corresponding to an operation of the brake operation member using the hydraulic fluid delivered from the manual hydraulic pressure source;
a simulator cut valve that controls a flow of the hydraulic fluid into the stroke simulator; and
a control unit that controls an open/closed state of the simulator cut valve and the pressure control mechanism, wherein:
the manual hydraulic pressure source includes a first hydraulic pressure generation unit that is connected to the power hydraulic pressure source and that generates a hydraulic pressure which assists a force, with which the brake operation member is operated, using the hydraulic fluid that is pressurized in the power hydraulic pressure source, and a second hydraulic pressure generation unit that is connected to a passage which leads to the stroke simulator and that generates a hydraulic pressure which corresponds to a sum of the force, with which the brake operation member is operated, and the hydraulic pressure generated in the first hydraulic pressure generation unit; and
while the pressure control mechanism controls the hydraulic pressure that is transferred to the wheel cylinder using the hydraulic pressure of the hydraulic fluid in the power hydraulic pressure source, the control unit closes the simulator cut valve when the hydraulic pressure of the hydraulic fluid in the power hydraulic pressure source falls below a predetermined value.

2. The brake control apparatus according to claim 1, wherein:
the hydraulic circuit includes:
a first hydraulic circuit which connects the manual hydraulic pressure source to a first wheel cylinder that applies a braking force to a first wheel, and in which a passage is formed so that the hydraulic pressure of the hydraulic fluid in the manual hydraulic pressure source is transferred to the first wheel cylinder,
a second hydraulic circuit which connects the manual hydraulic pressure source to a second wheel cylinder that applies a braking force to a second wheel that differs from the first wheel, and in which a passage is formed so that the hydraulic pressure of the hydraulic fluid in the manual hydraulic pressure source is transferred to the second wheel cylinder, and
a third hydraulic circuit which connects the power hydraulic pressure source to the first wheel cylinder and the second wheel cylinder, and in which a passage is formed so that the hydraulic pressure of the hydraulic fluid in the power hydraulic pressure source is transferred to the first wheel cylinder and the second wheel cylinder,
the stroke simulator is connected to the first hydraulic circuit and the second hydraulic pressure generation unit is connected to the first hydraulic circuit.

3. The brake control apparatus according to claim 2, further comprising:
an operation times detection unit that detects the number of times the brake operation member is operated, wherein
the control unit closes the simulator cut valve when it is determined that the number of times the brake operation member is operated within a predetermined period is equal to or larger than a predetermined value.

4. A brake control apparatus that controls braking forces which are applied to wheels based on a hydraulic pressure of a hydraulic fluid, comprising:
a manual hydraulic pressure source that pressurizes the hydraulic fluid based on an amount by which a brake operation member is operated by a driver;
a power hydraulic pressure source that is able to deliver the hydraulic fluid pressurized by supplied drive power independently of any operations of the brake operation member;
an operation times detection unit that detects the number of times the brake operation member is operated;
a first hydraulic circuit which connects the manual hydraulic pressure source to a first wheel cylinder that applies a braking force to a first wheel, and in which a passage is formed so that the hydraulic pressure of the hydraulic fluid in the manual hydraulic pressure source is transferred to the first wheel cylinder;
a second hydraulic circuit which connects the manual hydraulic pressure source to a second wheel cylinder that applies a braking force to a second wheel that differs from the first wheel, and in which a passage is formed so that the hydraulic pressure of the hydraulic fluid in the manual hydraulic pressure source is transferred to the second wheel cylinder;
a third hydraulic circuit which connects the power hydraulic pressure source to the first wheel cylinder and the second wheel cylinder, and in which a passage is formed so that the hydraulic pressure of the hydraulic fluid in the power hydraulic pressure source is transferred to the first wheel cylinder and the second wheel cylinder;
a pressure control mechanism that switches a passage through which the hydraulic fluid that is supplied from at least one of the manual hydraulic pressure source and the power hydraulic pressure source flows, thereby controlling the hydraulic pressure of the hydraulic fluid that is transferred to at least one of the first wheel cylinder and the second wheel cylinder;
a stroke simulator that is connected to the first hydraulic circuit and that generates a reaction force corresponding to an operation of the brake operation member using the hydraulic fluid delivered from the manual hydraulic pressure source;
a simulator cut valve that controls a flow of the hydraulic fluid into the stroke simulator;
a control unit that controls an open/closed state of the simulator cut valve and the pressure control mechanism; and
the manual hydraulic pressure source includes a first hydraulic pressure generation unit that is provided between and connected to the power hydraulic pressure source and the second hydraulic circuit and that generates a hydraulic pressure which assists a force, with which the brake operation member is operated, using the hydraulic fluid that is pressurized in the power hydraulic pressure source, and a second hydraulic pressure generation unit that is connected to the first hydraulic circuit and that generates a hydraulic pressure which corresponds to a sum of the force, with which the brake operation member is operated, and the hydraulic pressure generated in the first hydraulic pressure generation unit; wherein:
while the pressure control mechanism controls the hydraulic pressure that is transferred to the first wheel cylinder and the second wheel cylinder using the hydraulic pressure of the hydraulic fluid in the power hydraulic pressure source, the control unit closes the simulator cut valve when it is determined that the number of times the brake operation member is operated within the predetermined period is equal to or larger than the predetermined value.

5. The brake control apparatus according to claim 2, further comprising:
a stroke sensor that detects a stroke amount of the brake operation member, wherein
the control unit closes the simulator cut valve when the stroke amount of the brake operation member reaches a predetermined amount.

6. The brake control apparatus according to claim 2, wherein:
the control unit includes a road surface condition estimation unit that estimates a road surface condition that is correlated with slip of the wheel after antilock control is started; and
the control unit changes timing for closing the simulator cut valve based on the road surface condition.

7. The brake control apparatus according to claim 6, further comprising:
a stroke sensor that detects a stroke amount of the brake operation member; and
a hydraulic pressure sensor that detects the hydraulic pressure which is transferred to at least one of the first wheel cylinder and the second wheel cylinder, wherein
the road surface condition estimation unit estimates a coefficient of friction between the wheel and the road surface based on a pressure-decrease start pressure at which the hydraulic pressure that is detected by the hydraulic pressure sensor starts decreasing after the antilock control is started, and uses the estimated coefficient of friction as the road surface condition, and
the control unit closes the simulator cut valve after the stroke amount of the brake operation member reaches a predetermined amount that is set based on the coefficient of friction.

8. The brake control apparatus according to claim 7, wherein the predetermined amount is increased with an increase in the coefficient of friction.

9. The brake control apparatus according to claim 4, further comprising:
a stroke sensor that detects a stroke amount of the brake operation member, wherein
the control unit closes the simulator cut valve when the stroke amount of the brake operation member reaches a predetermined amount.

10. The brake control apparatus according to claim 4, wherein:
the control unit includes a road surface condition estimation unit that estimates a road surface condition that is correlated with slip of the wheel after antilock control is started; and
the control unit changes timing for closing the simulator cut valve based on the road surface condition.

11. The brake control apparatus according to claim 10, further comprising:
a stroke sensor that detects a stroke amount of the brake operation member; and
a hydraulic pressure sensor that detects the hydraulic pressure which is transferred to at least one of the first wheel cylinder and the second wheel cylinder, wherein
the road surface condition estimation unit estimates a coefficient of friction between the wheel and the road surface based on a pressure-decrease start pressure at which the hydraulic pressure that is detected by the hydraulic pressure sensor starts decreasing after the antilock control is started, and uses the estimated coefficient of friction as the road surface condition, and
the control unit closes the simulator cut valve after the stroke amount of the brake operation member reaches a predetermined amount that is set based on the coefficient of friction.

12. The brake control apparatus according to claim 11, wherein the predetermined amount is increased with an increase in the coefficient of friction.
